(19) United States
(12) Patent Application Publication
(10) Pub. No.: US 2012/0177353 A1
(43) Pub. Date: Jul. 12, 2012

(54) Laser Point of View and Camera Focus Assist Device and Method of Use

(76) Inventor: Michael Dowell, Lexington, KY (US)

(21) Appl. No.: 13/345,989

(22) Filed: Jan. 9, 2012

Related U.S. Application Data
(60) Provisional application No. 61/431,530, filed on Jan. 11, 2011.

(51) Int. Cl. G03B 13/36; G03B 11/00

(52) U.S. Cl. 396/106; 33/266

(57) ABSTRACT

A camera aiming and focus assist device using a laser to generate a point of view beam, and method of using the device is disclosed. The device projects a visible beam of light to create a focus spot on an intended subject to be photographed which allows a photographer to select a subject without looking through the camera view finder, and which allows the camera to focus on the desired subject in low light situations or in crowded or obstructed fields of view.

### CROSS REFERENCE TO RELATED APPLICATIONS

This application is a continuation in part of U.S. Provisional Application Ser. No. 61/431,530 filed Jan. 11, 2011.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### FIELD OF THE INVENTION

The present invention relates to a device to improve the ability of an autofocus camera to focus. More particularly the invention relates to a laser light pinpointing system attached to a camera or lens that places an illuminated focus spot on the subject to be photographed to allow the autofocus to lock onto the subject, and is configured to place the focus spot at or near the center of the field of view of the camera.

### BACKGROUND OF THE INVENTION

Focusing a camera once required the adjustment of a focus ring which allowed the photographer to adjust the focal length of the camera lens to place the subject, or object to be photographed, into focus. The development of autofocus cameras and lenses has made focusing much easier for many applications. The photographer merely points the camera at the desired object to be photographed, and the lens automatically focuses. Autofocus cameras and lenses are well known in the art, and virtually every camera manufacturer makes auto-focus cameras, and most cameras now on the market have the autofocus feature.

While the auto-focus on lenses and cameras have made photography much simpler for most users, it does not solve every problem. Auto-focus lenses focus on the most prominent object in or near the center of the field of view. Typically this is the closest, the largest, or the brightest object near the center of the field of view. Often a photographer wants to take a picture of a different object in the field of view. One representative example is a wild-life photographer who wants to take a picture of a single animal in the middle of a herd, or take the picture of a small animal in a tree partially obscured by branches. In these situations the auto-focus lens will have a difficult time picking out the specific subject to be photographed from the other objects in the field of view. There is a need, therefore, for a system or device to allow a photographer to focus an auto-focus camera on a desired subject in a crowded or obscured field of view.

There are times when a photographer wishes to take a picture through a window or through other intermediate clear or opaque surfaces such as the surface of water. In these situations the autofocus feature of the camera or lens will automatically focus on the intermediate surface, and the photographer will have to override the autofocus feature to take a picture through a window or intermediate surface. There is a need, therefore, for a method or device to allow a photographer to focus an auto-focus camera on an object on the other side of a window, or through the surface of water or other similar surfaces. There are also times when a photographer wishes to take a picture in low light or dark settings, but not rely on external lighting, or the “pre-flash” feature of many modern cameras, which produce a short flash of light to allow the auto-focus to acquire the focus lock. Wild-life photographers, for example, often need to observe a subject in near total dark before taking a picture. Lights, or a “pre-flash,” will obviously startle an animal and ruin the shot. There is a need, therefore, for a method or device to allow a photographer to focus a camera in low light or near dark situations.

A similar problem exists when attempting to focus in large solid color situations, such as when taking a picture against a wall or other monochromatic surface. In those situations, like in low light, the autofocus lens tends to hunt for a focus lock or a focal point. The problem is that there is not a well defined point for the focusing mechanism to acquire a focus. There is a need, therefore, for a system or apparatus to impart a focal point on a subject on monochromatic surfaces.

Many photographers often miss photo opportunities and photographic details due to the limited field of view supplied by the camera view finder. When preparing to take or while actively taking a picture the camera must be raised in front of the user's face to allow the photographer to select the desired subject in the field of view. This is true whether the photographer is using the view finder, or using the digital display on the back of modern digital cameras. (The term view finder will be used inclusively herein to describe both the standard view finder and modern visual digital displays.) This limits the photographer's field of vision to what is viewed through the view finder of the camera, while eliminating all peripheral vision and detail that would be seen with an unrestricted view. This is particularly true but not confined to, news photographers, sports photographers, or wildlife photographers, where there are potential subjects all around the photographer. Often in these situations the photographer will hold the camera away from the face to have a natural field of view to be able to select a subject for the photograph. Once the subject is selected the photographer must bring the camera to the eye to focus and shoot. While this may only take a matter of seconds, it is still long enough in many cases to lose the shot. There is a need, therefore, for a system that can acquire a subject, pinpoint a focal point, and autofocus the camera without eliminating peripheral view or restricting the photographer's field of vision.

### SUMMARY OF THE INVENTION

The present invention is a laser point of view (LPOV) device that is aligned with a camera lens and shines a small laser light on the desired subject to create a small but highly intense illuminated focus spot at or near the center of the field of view, which allows the auto-focus feature of the camera to focus on the desired subject of the photograph.

The invention provides a laser point of view focus assist for film and digital single lens reflex cameras and fixed lens cameras. The LPOV system comprises a green class two (II) laser module that is controlled by a circuit board and powered by an internal battery source that is activated by a button or switch. The laser is a 532 nm wavelength laser which produces visible light in the green spectrum, which is the color most easily seen by the human eye. The laser produces a small but highly intense focus spot which is easily acquired by the autofocus lens. The LPOV is housed in a polycarbonate plastic shell that is narrower than a standard camera lens and the approximate depth of a camera body and approximately an inch thick. The LPOV attaches to the camera or lens by means of the tripod mounting bracket which is on the bottom of all cameras and incorporated onto many lenses. The female screw connection on the bottom of the camera or lens is standard across the industry, and the male screw used to mount the LPOV is sized to fit the standard female screw connection of the cameras or lenses. It is also possible to mount the LPOV to the camera hot shoe.

This invention pinpoints and highlights the center of an intended area or subject to be photographed, using a series of precise laser beam light impulses or a constant light beam that is visible at distances of up to four hundred (400) yards under optimal conditions. The LPOV also assists in obtaining a focus lock when using auto focus lenses in a crowded field of view or in low light situations. Use of this devise is accomplished by mounting the LPOV to the tripod mount located on the bottom of a camera body, or to the tripod mount of a large lens. It is also possible to mount the LPOV to the flash hot shoe mount on the top of the camera. It is also possible to mount the LPOV anywhere on or in the camera body and project the beam of laser light through a fiber optic cable and through the camera lens. This can be done externally by projecting the light through the view finder, or internally by directing the light with a prism and through the lens.

In use, the photographer can locate the center point of the intended area to be photographed by pressing the power switch on the LPOV, which activates a laser light beam which will highlight the center of the intended area or subject to be photographed. In one configuration the light beam automatically ceases immediately prior to activating the camera shutter. Use of the LPOV not only produces a spot of light for the autofocus feature of the camera to focus on, but it also relieves the necessity of raising the camera up to and in front of the user's eye to take a picture. The photographer can determine the subject by viewing the light dot, and can be assured that the autofocus will properly focus the lens. This is particularly useful in low light situations or in a crowded field of view.

### BRIEF DESCRIPTION OF THE DRAWINGS

FIG. 1 is an exploded view of the LPOV in position to be mounted on the tripod mount of a camera.

FIG. 2 is an exploded view of the underside of the camera with the LPOV in position to be mounted on the tripod mount of the camera.

FIG. 3 is a side view of the LPOV mounted on the camera and projecting a beam that converges with the center point of the camera field of view.

FIG. 4 is side view of the LPOV mounted on the camera and projecting a beam to create a focus point on a subject at the center point of the camera field of view.

FIG. 5 is a representative view of the field of view of the camera.

FIG. 6 is a side view of the LPOV mounted on the camera and projecting a beam to position a focus point on a subject in a crowded field of view.

FIG. 7 is a side view of the LPOV mounted on a camera and projecting a beam to create a focus point to allow a photographer to aim the camera without looking through the lens finder.

FIG. 8 is a side view of the LPOV mounted on a camera and projecting a beam through a partial obstruction to create a focus point on a subject.

FIG. 9 is a top plan view of the LPOV.

FIG. 10 is a bottom plan view of the LPOV.

FIG. 11 is a plan view of the front of the LPOV.

FIG. 12 is a plan view of the back of the LPOV.

FIG. 13 is a top view of the LPOV bottom housing.

FIG. 14 is a top view of the battery door.

FIG. 15 is a top view of the laser module.

FIG. 16 is a top view of the battery holder.

FIG. 17 is a top view of the power button.

FIG. 18A-D are the top (18A), front (18B), side (18C), and bottom (18D) of the laser cradle.

FIG. 19A is a front view of the T-slider, and FIG. 19B is a front view of the T-slider inserted in the slider slot.

FIG. 20 is a side view of the laser cradle with the laser in place, the torsion spring in place, and the T-slider in place.

FIG. 21 is a front view of the laser cradle with the laser in place, the torsion spring in place, and the T-slider in place in the slider slot.

FIG. 22 is a top view of the bottom housing with the battery pack and power button in place, and with the laser module in the laser cradle.

FIG. 23 is an underside view of the top housing.

FIG. 24 is a cut away detail of the cradle housing with the laser module in place.

FIG. 25 is a side view of the LPOV mounted on the tripod mount of a lens.

FIG. 26 is an exploded view of the LPOV in place to be mounted on the hot shoe of a camera.

FIG. 27 is a detail of the hot shoe mount ball adapter.

### DETAILED DESCRIPTION OF THE INVENTION

Detailed embodiments of the present invention are disclosed herein. It is to be understood that the disclosed embodiments are merely exemplary of the invention, and that there may be a variety of other alternate embodiments. The figures are not necessarily to scale, and some features may be exaggerated or minimized to show details of particular components. Therefore, specified structural and functional details disclosed herein are not to be interpreted as limiting, but merely as a basis for teaching one skilled in the act to variously employ the present invention.

The invention consists of a Laser Point of View (LPOV) housing 100 that is mounted onto a camera 10. The housing 100 contains a mechanism that allows a laser 450 to project a beam 200, and a mechanism to allow the beam 200 to be adjusted to create a focus point 250 on a subject S to be photographed. Details of these components are discussed below.

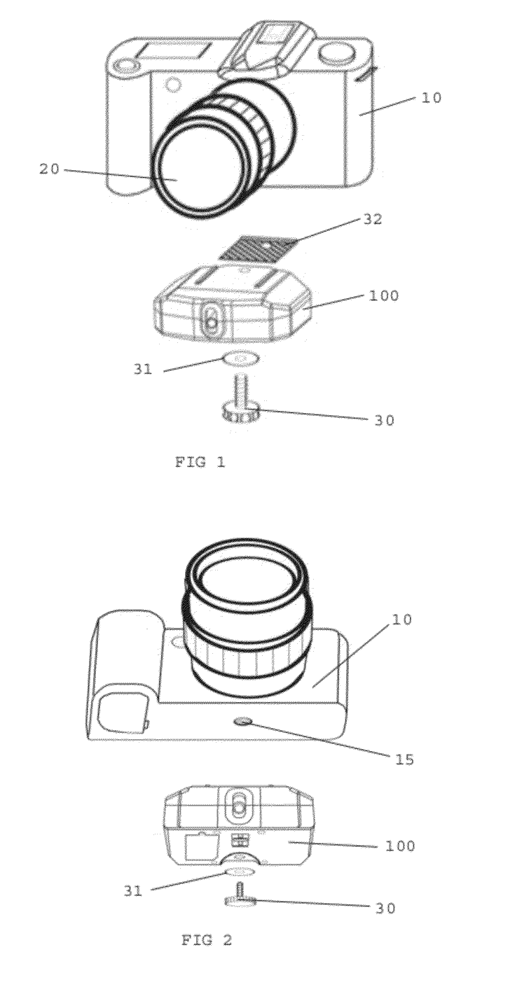

As shown in FIGS. 1 & 2, the LPOV housing 100 is mounted to the tripod mount 15 of the camera 10. Tripod mounts 15 are standard features of virtually all modern cameras from simple digital point and shoot devices to high end SLR (Single Reflex Lens) cameras. The tripod mount 15 is located directly under the lens, and it is industry practice for the tripod mount 15 to be centered under the lens 20, which means that it is positioned along the vertical centerline of the camera lens 20, as described below. Tripod mounts 15 are standard sized nuts so that all common tripods, and many other photography devices, can be easily mounted onto the camera 10. The LPOV 100 is attached to the tripod mount 15 by means of a thumb screw 30. The thumb screw 30 is threaded to correspond to the nut of the tripod mount 15 for easy attachment. The thumb screw 30 has a large head for easy turning and use. There is a cushioning washer 31 that sits between the thumb screw 30 and the underside of the LPOV 100 and a protective pad 32 that sits between the LPOV 100 and the tripod mount 15 to cushion the LPOV 100 and to allow the LPOV 100 to be snugly and securely attached to the camera 10 without undue compression of the LPOV 100. In the most preferred embodiment the protective pad 32 is approximately two (2) inches by two (2) inches, and is made from rubber or soft plastic or other suitable cushioning material.

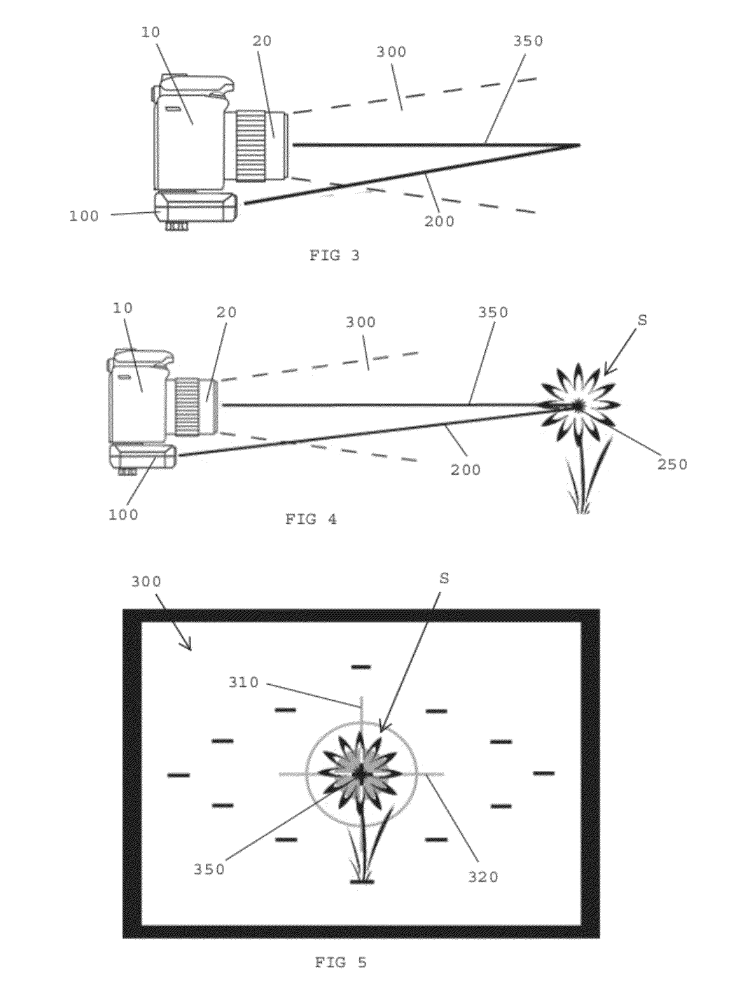

As seen in FIGS. 3 & 4, when mounted under the camera 10 and in operation, the LPOV 100 produces a beam of light 200 that projects out from below the camera 10 and produces a focus spot 250, or point of light, on a subject S. The focus spot 250 is a highly intense spot of light, and the autofocus feature of the camera 10 or lens 20 will focus on the spot 250. The subject S can be any object that the photographer P wishes to photograph, or take a picture of. Because of the configuration of the LPOV 100 on the camera 10, the light beam 200 is projected on the vertical centerline 310 of the camera field of view 300. The field of view 300 is shown in FIG. 5. The field of view 300 is what the photographer P will see when looking into the camera view finder, or on modern digital cameras when looking at the digital LCD display on the back of the camera 10. Such view finders and digital screens are well known in the art and not describe further herein, but will be referred to collectively as view finders. The field of view 300 also represents what will appear in the photograph, and is based on the visual image visible through the camera 10 and lens 20. In the representative example shown in FIGS. 4 & 5, the camera 10 is aimed at, and focused on the subject S, which in FIGS. 4 & 5 is a flower. The field of view 300 has a vertical centerline 310 and a horizontal centerline 320. The vertical centerline 310 and horizontal centerline 320 cross at the centerpoint 350 of the field of view 300. The center point 350 is seen as a spot in the field of view 300, but will be an imaginary line when viewed from the side, with the center point line 350 extending from the end of the lens 20 to the subject S. The vertical centerline 310 and horizontal centerline 320 can be any orientation in relation to the earth's horizon, however when the photographer P is standing upright and holding the camera in the standard orientation, the horizontal centerline 320 will be roughly parallel with the earth's horizon.

As shown in FIG. 4, the LPOV 100 generates a light beam 200, which places a focus spot 250 on the subject S, in this case the center of a flower. As seen in FIG. 5, the center of the flower is located at the centerpoint 350 of the field of view 300. With standard autofocus lenses, the lens will focus on the brightest spot at or near the centerpoint 350. The projection of the focus spot 250 onto or near the centerpoint 350 allows the camera to focus precisely on the subject S desired by the photographer P.

The LPOV 100 is mounted below the lens 20, which means that the beam 200 and the focus spot 250 will be below the centerline 350 of the field of view 300. The distance below the centerline 350 will be a product of how close the field of view and the focus is to the subject S. This can best be explained by describing the actual distance of the camera 10 from the subject S. If the front of the camera lens 20 is only a few feet from the subject S, for example in a close up picture, the focus spot 250 will be roughly the same distance below the horizontal centerline at the subject S as at the camera 10. If, in contrast, the subject S is at a great distance from the photographer, and the focus is of a large and natural field of view from that distance, as opposed to a zoomed close up, the focus spot 250 will still be below the center point 350 of the field of view, but this will be nearly imperceptible in the field of view of the camera.

Typically the LPOV 100 is mounted to the tripod mount 15 below the camera 10, or below the lens 20. This puts the LPOV 100 roughly an inch below the bottom of the lens 20. While lenses come in a wide range of physical sizes, depending on the type of lens, the most common lens diameter is approximately three inches, with a radius of approximately one and a half inches (1.5″). This means that the center point 350 of the field of view 300, which corresponds to the physical center of the lens 20, is about an inch and a half above the bottom of the lens 20, which means that LPOV 100 is about two and a half inches below the center of the lens 20. This means that for a subject S close to the lens 20, as well as for a field of view in a zoomed close up, the focus spot 250 will be as much as two and a half inches below the center point 350 of the field of view 300. As can be appreciated, there are many situations where this will not be acceptable because the autofocus tends to lock and focus on objects in or near the center of the field of view, particularly when they are the clearest or brightest objects. When the subject is at great distance the focus spot 250 will only be a tiny bit below the center point 350. But as can be appreciated, and because of the properties of the autofocus camera lenses, it is desirable to have the focus spot 250 at or near at the center point 350 of the field of view 300 to allow the autofocus lens to focus properly, and to allow the possibility of a close up photograph. The LPOV 100 contains an adjustment mechanism to move the focus spot 250 up and down the vertical centerline 310 and therefore closer to the centerpoint 350. This mechanism is described in detail below.

One of the key features of the LPOV 100 is that it allows the photographer to take a picture of a subject located in a crowded image field. Typically in a crowded field of view an autofocus camera will hunt for focus and may focus lock on the clearest or brightest object in the field of view, which may not be the desired subject S of the photograph. As shown in FIG. 6, when the subject S is located in or amongst other objects, the LPOV can place the focus spot 250 directly on the desired subject at the center point 350 of the field of view, which will allow the autofocus features of the camera 10 to focus on the specific subject and not other brighter or clearly subjects within the field of view. A similar problem with focus lock occurs in low light or in the dark, or when taking a picture with a monochromatic background. It is often very difficult for an autofocus lens to acquire an image and lock the focus in low light or against a monochromatic background. In those cases the lens will search in vain for an object to focus on. With the LPOV 100 the photographer P can use the laser focus spot 250 to select a subject and the autofocus lens will focus lock on the spot 250, and the photographer P can then take the picture. It is also often difficult to select a subject S and focus the camera while looking through the view finder in low light situations because of the limited field of view. The LPOV 100 resolves that problem.

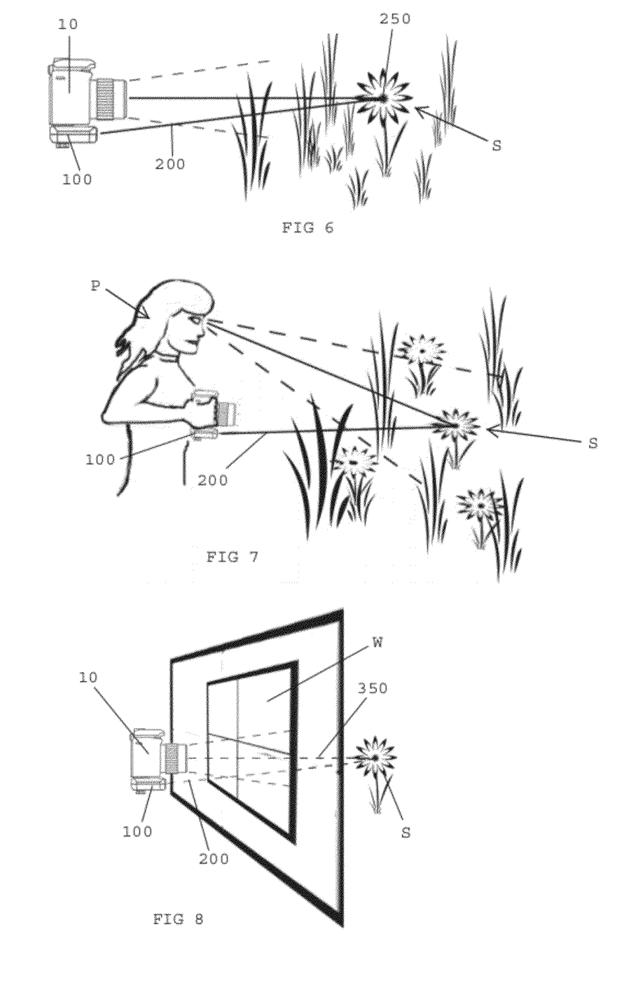

As shown in FIG. 7, the LPOV 100 allows the photographer P to aim the camera and select a subject S without looking directly through the view finder. The laser 450 of the LPOV 100 projects a visible light beam 200 onto an object to create a focus spot 250. In the most preferred embodiment the laser is a green laser, which produces light that is most easily seen by the human eye. The green laser will produce an easily observed green focus spot 250, which will the photographer P to aim the camera 10 by moving the light beam and the focus spot 250. This allows the photographer P to have a full range of view of the environment around him or her. This is particularly useful in crowded environments or particularly actively environments, such as sports events, where the photographer P would be at a disadvantage looking at things through the camera view finder. It allows the photographer P to take select a subject and take a picture with confidence that it will be in focus, even without looking through the view finder. This can be useful in a variety of situations. One example is news photography where the photographer P may need to hold the camera over the head and over a crowd.

The LPOV 100 also allows the photographer to focus the camera through obstructions, like a window or the surface of water. Typically if taking a picture through a glass window or through the surface of water the autofocus will focus on the glass or the water surface. This is because those objects are in focus and are near the center of the field of view, so the autofocus naturally locks onto those surfaces. It is possible for the photographer P to manually refocus the camera 10, but in some situations the desired photograph can be lost. As seen in FIG. 8, the light beam 200 shines through the glass of the window W to produce the focus spot 250 on the subject S. It is the nature of laser light to be able to shine through a intermediate surface with minimal refraction, so the beam 200 will still create the light spot 250 when shown through a window W.

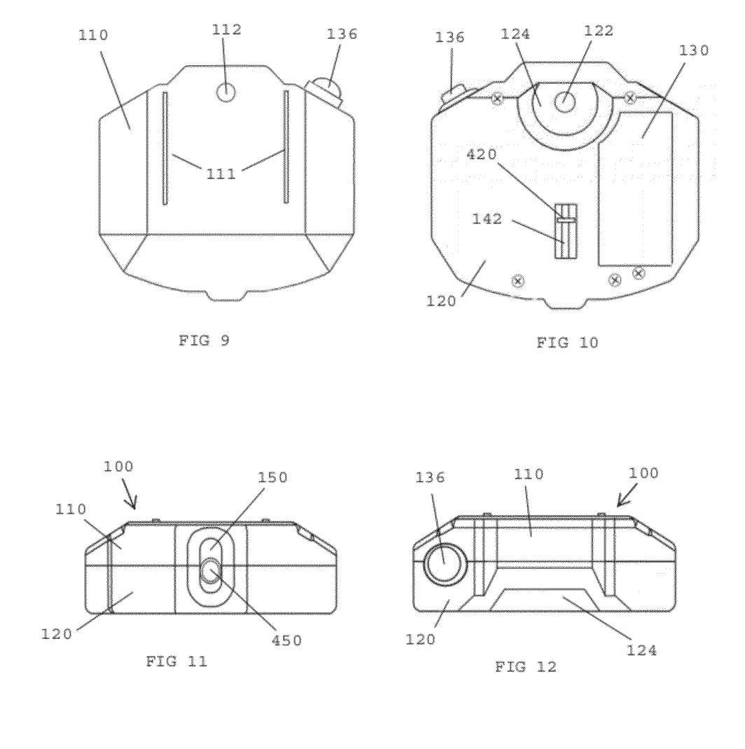

In the preferred embodiment the LPOV 100 consists of a plastic housing that holds a battery pack, a laser module comprised of a laser with controller circuitry, an on-off switch that controls the power from the battery pack to the laser, and a mechanism for adjusting the horizontal movement of the laser. As seen in FIGS. 9, 10, 11 & 12, the LPOV housing 100 consists of a housing top 110 and a housing bottom 120 that are made from injected plastic molding and configured to attach as described further herein. In the most preferred embodiment of the invention the housing of the LPOV 100 is made from polycarbonate or molded plastic material. In alternate embodiments of the invention the LPOV 100 could be made out of any suitably strong and thin material such as aluminum, metal alloy, plastic, plastic composites, or resin based materials.

The LPOV 100 is sized to fit easily under a standard camera. In the preferred embodiment of the invention the LPOV 100 is approximately 3 inches wide, just under three inches in length, and just over 1 inch in height. The actual dimensions can vary based on production requirements, with the main requirement being ease of attachment to standard cameras and lenses by means of tripod or hot shoe mounts. In the preferred embodiment the LPOV 100 is approximately the same size as a standard battery pack that is mounted under the camera. The LPOV 100 can also be mounted with the DeluxGear Lens Cradle, which is described in U.S. Pat. No. 7,766,562 to Dowell, and entitled “Support Cradle and Strap for Large Camera Lens.”

The housing top 110 has a top thumb-screw hole 112, and the housing bottom 120 has a bottom thumb-screw hole 122 that is aligned with the top thumb-screw hole 112 when the housing top 110 is in place on the housing bottom 120, and through which the thumb screw 30 is inserted to mount the LPOV 100 to the camera 10. There are two parallel guide rails 111 on top of the housing top 110. The protective pad 32 is sized to sit between the guide rails 111. The guide rails 111 are important for mounting the LPOV 100 to the tripod mount 25 of separate lenses 20, as will be described below. The underside of the housing top 110 has a series of small threaded screw holes 117 to allow the attachment of the housing bottom 120.

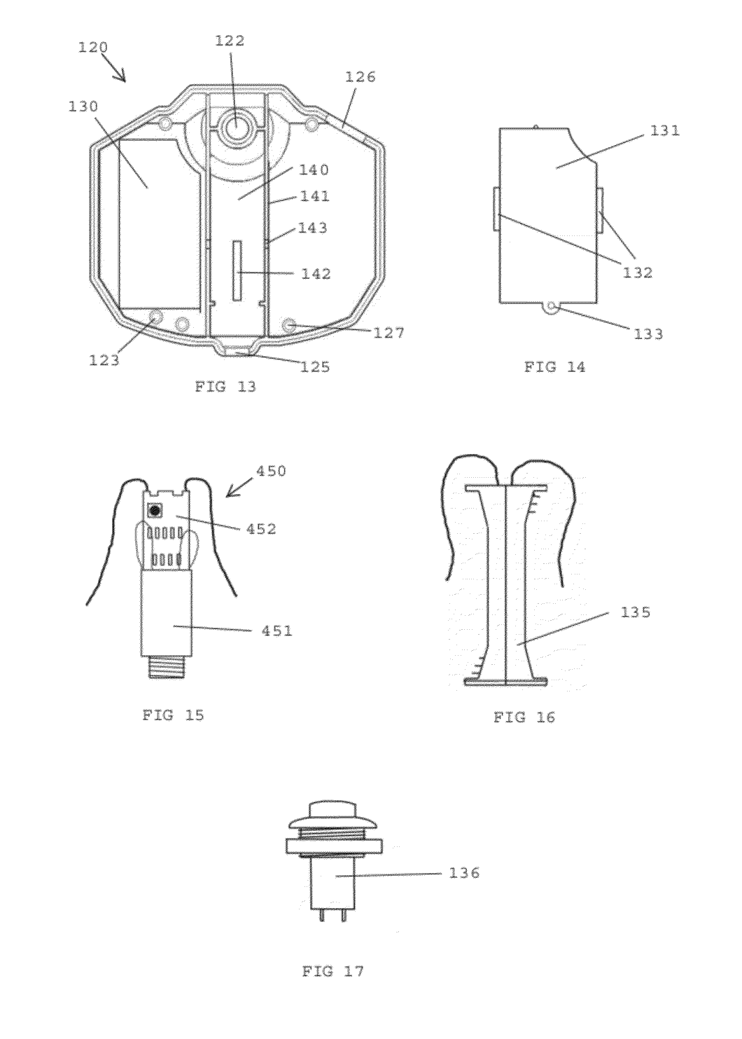

As shown in FIG. 13, the inside of the housing bottom 120 has a battery tray door opening 130 sized to accommodate a battery tray door 131, which is shown in FIG. 14. The battery tray door 131 is held in place within the battery tray door opening 130 by means of two tabs 132 on the door 131 and corresponding slots on the door opening 130, and a small screw tab 133 on the door 131 that corresponds to a small screw hole 123 on the housing bottom 120 to allow the battery tray door 131 to be secured in place. The configuration of similar battery tray doors and openings is common among small electronic equipment such as phones and remote control devices, and is well known in the art. There are four attachment screw holes 127 for attaching the housing bottom 120 to the housing top 110. The bottom screw holes 127 are aligned with the top screw holes 117 to allow the housing top 110 to be securely attached to the housing bottom 120 by means of four appropriately sizes screws.

Adjacent to the door opening is the laser cradle housing 140 which consists of two parallel cradle housing side walls l41 with two co-axial pin holes 143, and a slider slot 142 on the bottom that is an elongated slot in the housing bottom 120. The laser cradle 400 sits in the cradle housing 140. At the end of the cradle housing 140 there is a laser window 150, which is created by the laser window bottom 125 in the housing bottom, and the laser window top 115 in the housing top 110.

There is a laser module 450 that consists of a laser 451 and an integrated control circuitry 452, as shown in FIG. 15. Such small laser modules with integrated laser and control circuitry are well known in the art. In the preferred embodiment, the laser module 450 is an off-the-shelf Diode Pumped Solid State (DPSS) laser module commonly used for small laser devices such as astronomical or surveyor laser pointers. In the most preferred embodiment of the invention, the LPOV is fitted with one green 532 nm 1 W class two (II) laser module. This is the most preferred laser because the 555 nm wavelength lies near the center of the human eye's most sensitive reception curve, and this color is, therefore, the most easily seen by the human eye. The internal components of the DPSS laser 450 are well known in the art and relatively standard. They are described herein for reference purposes only to help explain how the device works. There is a battery holder 135, shown in FIG. 16, of a type well known in the art, that provides power to the laser module 450. In the preferred embodiment the battery holder is sized and designed to hold standard AAA batteries. There is a power button 136, shown in FIG. 17, of a type well known in the art. The power button 136 is secured into the LPOV by means of a corresponding bottom power button opening 126 and top power button opening 116. The three electronic components, the battery pack 135, the laser module 450 and the power button 136 are connected electronically, as is well known in the art. The power button 136 controls the power and the on-off features of the laser integrated control circuitry 452. FIG. 22 shows all of these components in place in their respective positions within the housing bottom 120.

In one embodiment of the invention the laser light 200 will be a pulse beacon, with the light alternately on and off in intervals of a fraction of a second. One of the concerns with using laser light for the illuminated focus spot is that laser light can cause eye damage. In general eye damage has not been documented with the strength of laser used for this device. However, for higher power outputs of laser light, pulsing the light on and off will reduce the potential for eye damage.

In the most preferred embodiment, the power button 136 is assembled into the housing of the LPOV 100 and controlled directly by the photographer P. In an alternate embodiment of the invention the power button 136 may be relocated away from the LPOV 100 by means of wiring or cable, so that the activation of the laser 450 may be placed at other locations on the camera or even be controlled by a separate hand held switch. It is also possible, and within the conception of the invention, that the LPOV 100 could be activated or controlled by a remote control. It is also within the conception of the invention that the laser module 450 could be powered or controlled by the camera 10 components. In this alternate embodiment the LPOV 10 will be connected directly to the computerized electronic components of the camera.

As noted, in one configuration the LPOV 100 can be controlled by a simple on/off switch on the power button 136. This would keep the light beam 200 on during photography. So, for example, if the photographer P were taking pictures at a sporting event, the LPOV 100 would be constantly on and would allow the photographer P to view the action through the view finder and be instantly able to autofocus on a particular player or part of the action. This would allow the photographer P to aim the camera without looking through the view finder or focusing on the LCD display screen on the back of the camera, which would improve the photographer's field of vision and situational awareness of events around him or her. There are situations where it is desirable to have a full field of vision and not have it limited to the field of view of the camera view finder.

In another configuration the LPOV 100 would only come on for a brief period of time during the process of taking a picture. In certain configurations this can be accomplished by plugging the LPOV 100 into the camera auxiliary mount, by means of an USB cable or other connector as required by the particular model of camera, and allowing the camera to control the LPOV. Virtually all modern cameras have auxiliary equipment connection ports. Typically, with modern electronic cameras, these auxiliary equipment connectors are standard USB (Universal Serial Bus) connectors, but other connectors are available. Electronic cameras are highly computerized, and the auxiliary connectors are programmed into the camera so that the camera actually controls the auxiliary component. Perhaps the most common kind of auxiliary component is external lighting.

Standard cameras have a two position shutter release button. For most autofocus cameras the photographer will slightly depress, or push, the shutter release button, which will activate the autofocus features and will lock the autofocus onto the desired subject. The photographer will then push the button the rest of the way, which will activate the shutter and take the picture. By connecting the LPOV 100 to the camera auxiliary equipment port the camera will control the LPOV 100. When the photographer presses the shutter release button the LPOV 100 will come on, which will allow the photographer to acquire the desired subject S and allow the camera to focus on that subject. When the shutter release button is fully depressed the LPOV 100 will turn off and the picture will be taken, without the illuminated focus spot 250 in the photograph.

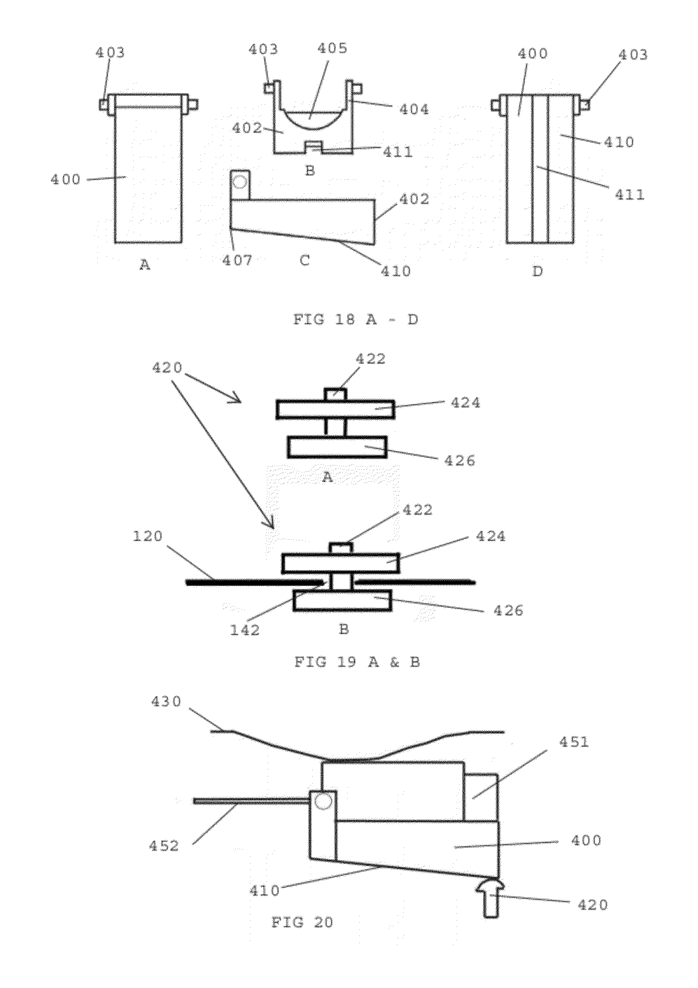

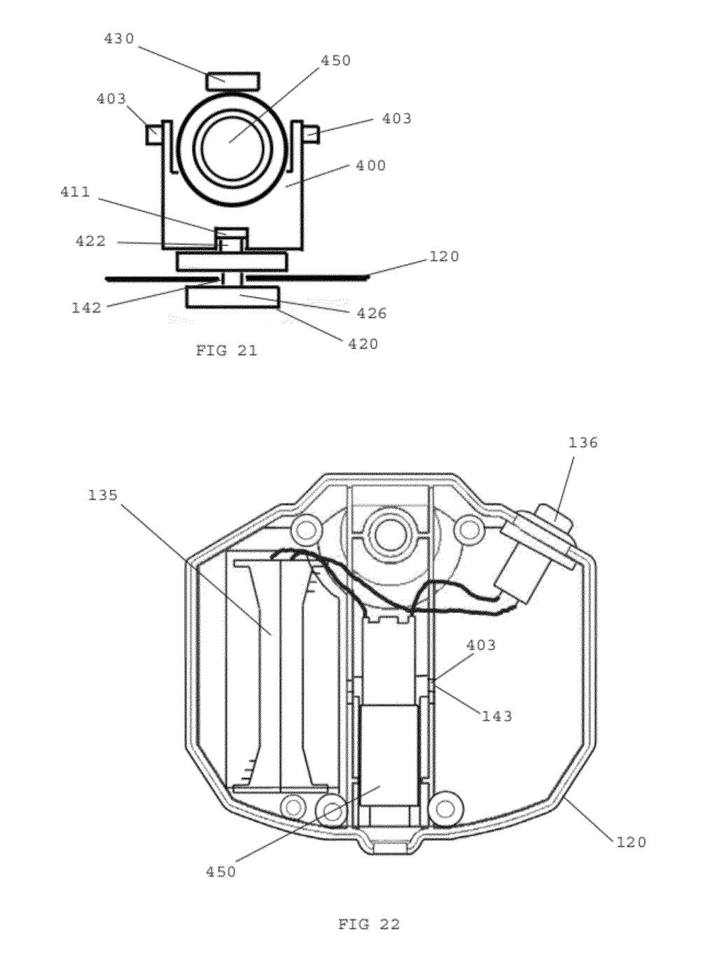

The laser cradle 400 is depicted in FIG. 18A-D. The beam 200 can be adjusted by means of the T-slider 420, which is shown in FIGS. 19A & 19B. The laser cradle 400 is sized to hold the laser 451 portion of the laser module 450, with control circuitry 452 extending out of the back of the cradle 400. The cradle 400 has a concave laser recess 405 on the top which is sized to hold the laser 451. There are two corresponding side tabs 404 that are oriented at the back 407 of the cradle 400, with two attachment pins 403 protruding from the tabs 404. When in place, the attachment pins 403 are inserted into the pin holes 143 of the cradle housing 140 to hold the cradle 400 in place, and to create a pivot point about which the cradle 400 can rotate. As seen in FIG. 18C, the cradle 400 has a beveled underside 410, with the back 407 narrower than the front 402. There is a slide channel 411 cut in the underside 410 of the cradle.

The T-slider 420 is shown in FIGS. 19A and 19B. The T-slider consists of a slide post 422 connecting a slide plate 424 and a slide controller 426. As seen in FIG. 19B, the slide post 422 sits within the slider slot 142, with the slide plate 424 sitting on the inside of the housing bottom 120, and the slide controller 426 attached to the slide post 422 just on the underside of the housing bottom 120. The T-slider 420 can be seen in cross section in FIG. 20 and FIG. 24. The components of the T-slider 420 are molded plastic and are either snap-fitted or glued together. The top portion of the slide post 422 rides in the slider channel 411 of the lens cradle 400, as seen most clearly in FIG. 21 and FIG. 24.

FIGS. 20, 21, and 24 show the laser cradle 400 in conjunction with the T-slider 420. The laser module 450 is held down by means of a torsion spring 430 which is placed on top of the laser 451 and against the underside to the housing top 110 when the housing top is attached to the housing bottom 120 and all the components are in place. As the T-slider 420 is moved in the slider slot 142, the cradle 400 rotates about the pins 403, and the beveled underside 411 allows the change in orientation. As the T-slider 420 is moved forward in the slider slot 142, the front 402 of the cradle 400 moves up, and as the T-slider 420 is moved back in the slider slot 142, the front 402 of the cradle 400 moves down. This means that when the laser 451 is on, the beam 200 will move with the movement of the T-slider 420. Moving the T-slider 420 forward towards the front of the LPOV 100 will move the beam 200 up the vertical centerline 310, and moving the T-slider 420 back moves the beam 200 down the vertical centerline 310. When the T-slider 420 is in the fully back position the beam 200 is projected parallel with the center point 350 projection line of the field of view 300. Because of the orientation of the LPOV 100 under the lens, this puts the beam about three inches below the center of the lens. At great distances this will put the focus spot 250 nearly at the center point 350 of the field of view 300. In one configuration the T-slider 420 can incorporate a number of preset tabs that would correspond to subject distance. So, for example, if the subject S is 100 feet from the photographer, the T-slider 420 would be aligned to the 100 foot tab, which would adjust the tilt of the laser to place the focus spot 250 at the center point 350 100 feet away from the camera 10. This would allow the photographer P to quickly and easily set the focus spot 250 to approximately the center of the field of view 300 at the desired subject distance. There could be present tabs at any set distance.

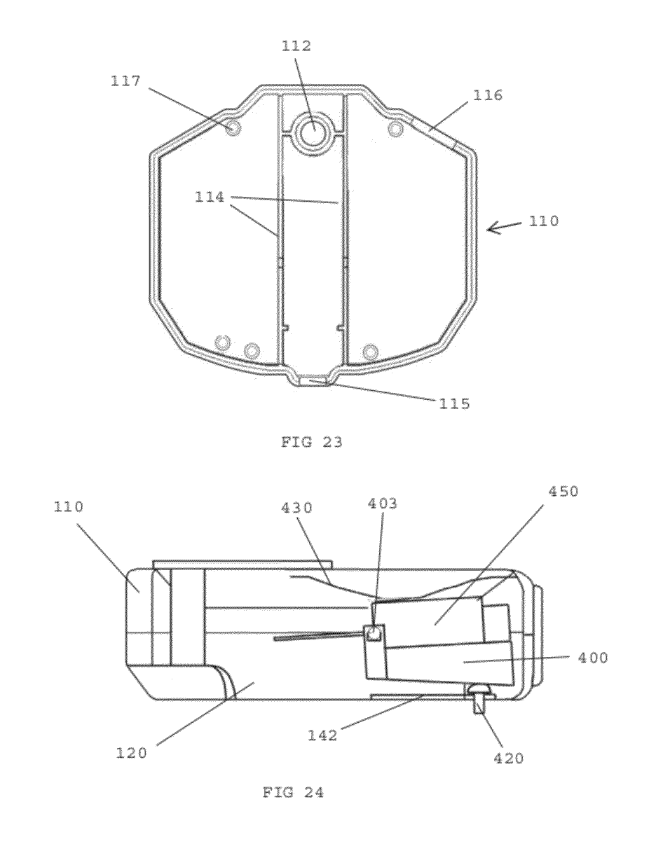

FIG. 23 shows the underside of the housing top 110. There are two parallel housing walls 114 that correspond with the side walls 141 of the housing bottom 120, so that, when in place, the cradle 400 is retained within the cradle housing 140. There are four screw holes 117 that correspond to the screw holes 127 of the bottom housing 120 to allow the two components to be securely attached. There is a laser window top 115 that aligns with and corresponds to the laser window bottom 125 to create the laser window 150 when the top 110 is attached to the bottom 120.

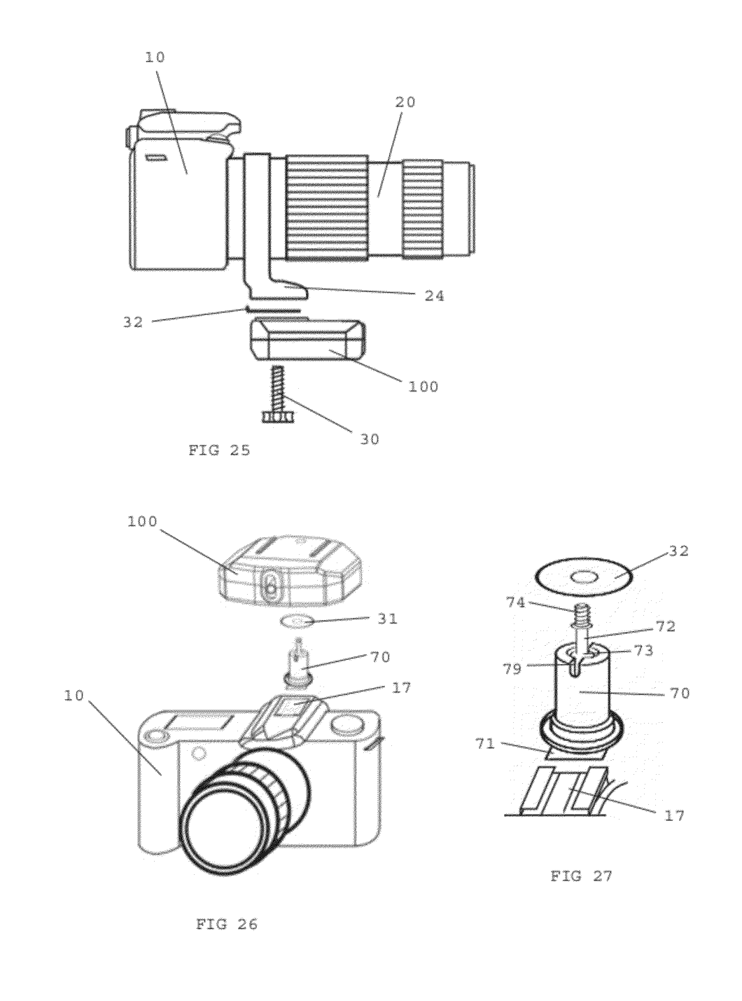

FIG. 25 shows the LPOV 100 in position to be mounted on a tripod mount 25 of a camera lens 20. Many large lenses have individual tripod mounts 25. The tripod mounts 25 have the same size nut as the camera tripod mount 15, and the thumb screw 30 fits these tripod mounts 25 as well. Lens tripod mounts 25 have a standard width and the guide rails 111 are spaced to fit on either side of the tripod mount 25.

FIG. 26 shows the LPOV 100 in position to be mounted to the camera hot shoe mount 17. Many cameras have “hot shoe” mounts for mounting flash and other external equipment. The size of the hot shoe mount is standard to allow the attachment of a wide variety of equipment across manufacturers. The hot shoe mount 17 is configured to align with the vertical centerline 310 of the lens, and as a result, when mounted on the hot shoe mount 17, the LPOV will be on the vertical centerline 310 of the field of view 300. FIG. 27 shows the details of the hot shoe mount ball head adapter 70. The ball head adapter has a shoe plate 71 that is sized and configured to snugly slide into the hot shoe mount 17. At the other end of the hot shoe adapter 70 there is a ball recess 79 and a ball head bolt 72 with the ball 73 of the bolt secured within the recess 79. The other end of the ball head bolt 72 has threads 74 that are sized and configured to attach to a LPOV nut 170 mounted in the bottom thumb screw hole 122.

It is also possible to use the LPOV with a video or film (motion picture camera). Many video and motion picture film cameras have auto focus that function in much the same way as autofocus on a still picture camera, where the autofocus acquires the nearest, brightest, or most prominent object in the field of view. The LPOV would function with the video in precisely the same way as with the still picture SLR camera, and would allow the operator to select the subject that the camera would focus on. This would be useful in shots of moving subjects, where the subject is changing its distance from the camera. Many autofocus video cameras will automatically adjust to keep the subject in focus, but if there is a larger, brighter or more prominent object the camera might lose focus. The LPOV will allow the photographer to precisely acquire and keep the desired subject in focus throughout the shot.

The LPOV is designed to work with any type of imaging device. It is specifically designed to work with all camera types and other current or future forms of image duplication or image capture, including, but not limited to SLR cameras operating with 8 mm, 16 mm, 35 mm and 70 mm film; DSLR cameras consisting of charge-coupled device (CCD) or a complementary metal-oxide-semiconductor (CMOS) sensors and other current or future forms of image duplication or capture; DSLR/Video cameras consisting of charge-coupled device (CCD) or a complementary metal-oxide-semiconductor (CMOS) sensors and other current or future forms of image duplication or capture; Digital Fixed lens cameras consisting of charge-coupled device (CCD) or a complementary metal-oxide-semiconductor (CMOS) sensors and other current or future forms of image duplication or capture; Digital and Film video cameras consisting of charge-coupled device (CCD) or a complementary metal-oxide-semiconductor (CMOS) sensors and 8 mm, 16 mm, 35 mm and 70 mm film and other current or future forms of image duplication or capture; Movie Cameras operating with 8 mm, 16 mm, 35 mm and 70 mm film; Analog and digital camcorders and image recorders using flash memory devices and hard disks, MPEG-1, MPEG-2 or MPEG-4, DV, HDV and solid-state (flash) and other current or future forms of image duplication or capture.

The LPOV can also be used for laser tracking and or location of animate or inanimate objects by use of a reflective or capture device; acquiring a location and or tracking of a subject with the use of a digital, film or analog image capture device equipped with a laser; laser assisted digital or video tracking or targeting with a digital, film or analog image capture device; laser tracking and or location of animate or inanimate objects by use of a reflective or capture device for search and or rescue.

The present invention is well adapted to carry out the objectives and attain both the ends and the advantages mentioned, as well as other benefits inherent therein. While the present invention has been depicted, described, and is defined by reference to particular embodiments of the invention, such reference does not imply a limitation to the invention, and no such limitation is to be inferred. The depicted and described embodiments of the invention are exemplary only, and are not exhaustive of the scope of the invention. Consequently, the present invention is intended to be limited only be the spirit and scope of the claims, giving full cognizance to equivalents in all respects.

I claim:

1. A method of focusing a camera comprising the steps of:
providing a camera with an autofocus lens, said lens having a field of view with a vertical centerline, a horizontal centerline, a centerpoint where the vertical centerline and horizontal centerline cross, and multiple preset autofocus points;
mounting a laser on said camera, said laser projecting a beam that produces a focus spot on a subject,
whereby said autofocus lens focuses on said focus spot.

2. The method of focusing a camera of claim 1 comprising the further steps of:
mounting said laser on said camera such that the beam projects along the vertical centerline
disposing an adjustment means on said laser to allow said beam to be adjusted up and down said vertical centerline, thereby allowing a user to place said focus spot on said centerpoint at varying distances from the lens.

3. The method of focusing a camera of claim 1 comprising the further steps of:
mounting a laser point of view mechanism on said camera;
disposing a laser within said laser point of view mechanism incorporating a battery to power said laser and a controller to activate said laser;
integrating an adjustment means within said laser point of view mechanism to allow said laser to be moved such that the beam can be adjusted within the field of view.

4. The method of focusing a camera of claim 3 comprising the further steps of:
incorporating internal controlling electronics within said camera; and
integrating said laser point of view mechanism with the internal controlling electronics such that the laser can be controlled through the camera.

5. The method of focusing a camera of claim 3 wherein said adjustment means consists of pivot mounted cradle having a beveled underside, said cradle disposed within the laser point of view device, said laser disposed within said cradle, and a slide mechanism that slides along said beveled underside to rotate said cradle about said pivot point to move the bean up and down the vertical centerline.

6. The method of focusing a camera of claim 3 wherein said adjustment means consists of a screw assembly that moves the front of the laser up or down, and which moves the beam up and down the vertical centerline.

7. The method of focusing a camera of claim 3 comprising the further steps of;
integrating a tripod mount on said camera; and
mounting said laser point of view mechanism on the camera tripod mount.

8. The method of focusing a camera of claim 3 comprising the further steps of;
attaching a lens on said camera, said lens having a lens tripod mount; and
mounting said laser point of view mechanism on the camera tripod mount.

9. The method of focusing a camera of claim 3 comprising the further steps of:
incorporating a standard hot shoe mount on said camera;
mounting said laser point of view mechanism on the hot shoe mount.

10. The method of focusing a camera of claim 3 comprising the further steps of:
generating said laser beam light in the visible green spectrum.

11. A method of aiming a camera having a view finder and a field of view, said method comprising the steps of:
disposing a laser beam generating device on the camera to project a beam of light within said field of view;
imparting a focus spot on a subject with the laser beam, said focus spot within the field of view;
acquiring a subject by moving the camera such that the beam and focus spot are moved to place the focus spot on to the subject;
wherein the photographer can select a subject without looking through the view finder of the camera.

12. The method of aiming a camera of claim 11, comprising the further steps of:
incorporating a laser beam adjustment means to allow the adjustment of the beam and the focus spot to a predetermined point within the field of view.

13. The method of aiming a camera of claim 11, comprising the further steps of:
incorporating a tripod mount on said camera; and
mounting said laser beam generating device to said tripod mount.

14. The method of aiming a camera of claim 11, comprising the further steps of:
attaching a lens having a lens tripod mount to said camera; and
mounting said laser beam generating device to said lens tripod mount.

15. The method of aiming a camera of claim 11, comprising the further steps of:
incorporating a hot shot on said camera; and
mounting said laser beam generating device to said hot shoe.

16. The method of aiming a camera of claim 11, comprising the further steps of:
generating said laser beam light in the visible green spectrum.

17. The method of aiming a camera of claim 11, comprising the further steps of:
generating said laser beam light at 532 nm wavelength.
